(19) United States
(12) Patent Application Publication
(10) Pub. No.: US 2007/0080904 A1
(43) Pub. Date: Apr. 12, 2007

(54) Plasma display device, driving apparatus and driving method thereof

(76) Inventor: Sang-Shin Kwak, Yongin-si (KR)

Correspondence Address: CHRISTIE, PARKER & HALE, LLP, PO BOX 7068, PASADENA, CA, 91109-7068, US

(21) Appl. No.: 11/544,100

(22) Filed: Oct. 5, 2006

(30) Foreign Application Priority Data
Oct. 11, 2005 (KR) 10-2005-0095365

(51) Int. Cl. G09G 3/28

(52) U.S. Cl. 345/68

(57) ABSTRACT

A plasma display, a driving apparatus and a method of driving the same is provided. A first transistor is coupled between a first electrode and a first power source, and a second transistor is coupled to the first electrode. A third transistor is coupled between the second transistor and a second power source, and a first inductor is coupled between the second transistor and a first energy recovery power source. A fourth transistor is coupled between the second electrode and the first power source, and a fifth transistor is coupled to the second electrode. A sixth transistor is coupled between the fifth transistor and the second power source, and a second inductor is coupled between the fifth transistor and a second energy recovery power source.

### CROSS-REFERENCE TO RELATED APPLICATION

This application claims priority to and the benefit of Korean Patent Application No. 10-2005-0095365 filed in the Korean Intellectual Property Office on Oct. 11, 2005, the entire content of which is incorporated herein by reference.

### BACKGROUND OF THE INVENTION

(a) Field of the Invention

The present invention relates to a plasma display, driving apparatus and driving method thereof. More particularly, the present invention relates to an energy recovery circuit of the plasma display, a driving apparatus and a driving method thereof.

(b) Description of the Related Art

A plasma display is a flat panel display that uses plasma generated by a gas discharge to display characters or images. The plasma display is driven by a plurality of subfields, which are divided from a frame. A turn-on discharge cell is selected among a plurality of discharge cells by performing an addressing discharge for an address period of each subfield, and the turn-on discharge cell is sustain-discharged for a sustain period of each field so as to display an image.

For such operations, during the sustain period, high and low level voltages are alternately applied to the electrodes for performing a sustain discharge. In this case, a capacitance exists on the panel due to a discharge space between scan and sustain electrodes performing sustain discharges. Because the discharge space operates as a capacitive load, an additional reactive power source as well as a power source for the sustain discharge is required so as to apply the sustain discharge pulses of the high and low level voltages to the two electrodes. Therefore, a typical sustain discharge driving circuit includes a power source recovery circuit for recovering and reusing the power from the reactive power source.

In the energy recovery circuit of the sustain discharge circuit, transistors and diodes for increasing a voltage of the electrode and those for decreasing the voltage of the electrode are separately formed. Therefore, the cost of the plasma display is increased.

### SUMMARY

One exemplary embodiment of the present invention provides a plasma display including a plurality of first electrodes, a plurality of second electrodes, first transistor, a second transistor, a third transistor, a fourth transistor, a fifth transistor, a sixth transistor, first and second capacitors and first and second inductors. The first transistor may be coupled between the plurality of first electrodes and a first power source for supplying a first voltage, and the fourth transistor may be coupled between the plurality of second electrodes and the first power source. The second transistor may have a body diode and be coupled to the plurality of first electrodes at a first terminal, and the fifth transistor may be coupled to the plurality of second electrodes at a first terminal and may have a body diode. The third transistor may be coupled between a second terminal of the second transistor and a second power source for supplying a second voltage, and the sixth transistor may be coupled between a second terminal of the fifth transistor and the second power source. The first inductor may be coupled between the second terminal of the second transistor and a first energy recovery power source, and the second inductor may be coupled between the second terminal of the fifth transistor and a second energy recovery power source.

The first and second energy recovery power sources may each supply a voltage of lower than approximately half of a third voltage corresponding to a difference between the first voltage and the second voltage. The first and second energy recovery power sources may each supply a voltage of lower than approximately ¼ of the third voltage, and the first energy recovery power source and the second energy recovery power source may each supply a voltage corresponding to approximately ⅛ of the third voltage.

Another exemplary embodiment of the present invention provides a driving method of a plasma display having a first electrode. The driving method includes inputting energy of a first capacitor into a first inductor while applying a first voltage to a first electrode during a first period. The method also includes inputting stored energy of the first inductor and energy of the first capacitor into the first electrode through a body diode of a first transistor coupled between the first inductor and the first electrode during a second period. The method also includes applying a second voltage that is higher than the first voltage to the first electrode during a third period; and recovering the stored energy of the first electrode to the first capacitor through the first transistor and the first inductor during a fourth period. The method also includes applying the first voltage to the first electrode during a fifth period.

Another exemplary embodiment of the present invention provides a driving apparatus of a plasma display having a first electrode and a second electrode for performing a sustain discharge along with the first electrode. The driving apparatus includes a first transistor having a first terminal adapted to be coupled to a first power source for supplying a first voltage, a second terminal adapted to be coupled to the first electrode, and a body diode enabling the formation of a current path from the second terminal to the first terminal. The driving apparatus also includes a second transistor having a first terminal adapted to be coupled to the first electrode, a second terminal, and a body diode enabling the formation of a current path from the second terminal of the second transistor to the first terminal of the second transistor. The driving apparatus also includes a third transistor having a first terminal coupled to the second terminal of the second transistor, a second terminal adapted to be coupled to a second power source for supplying a second voltage, and a body diode enabling the formation of a current path from the second terminal of the third transistor to the first terminal of the third transistor. The driving apparatus also includes a first capacitor for supplying a voltage of lower than approximately half of the difference between the first voltage and the second voltage. The drive apparatus also includes a first inductor coupled between the first capacitor and the fourth terminal of the second transistor.

### BRIEF DESCRIPTION OF THE DRAWINGS

FIG. 1 shows a schematic diagram of a plasma display according to an exemplary embodiment of the present invention.

FIG. 2 shows a sustain discharge pulse waveform according to an exemplary embodiment of the present invention.

FIG. 3 shows a schematic diagram of a sustain discharge circuit according to an exemplary embodiment of the present invention.

FIG. 4 shows a signal timing diagram of the sustain discharge circuit of FIG. 3.

FIGS. 5A, 5B, 5C, 5D, 5E, 5F, 5G and 5H show current paths of a sustain discharge circuit of FIG. 3 operated according to signal timings of FIG. 4.

### DETAILED DESCRIPTION

As used herein, the phrase “maintained at a predetermined voltage” should not be understood as “maintained exactly at a predetermined voltage”. To the contrary, even if a voltage difference between two points varies, the voltage difference is “maintained at a predetermined voltage” when the variance is within a range allowed in design constraints or when the variance is caused due to a parasitic component that is usually disregarded by a person of ordinary skill in the art. A threshold voltage of a semiconductor device (e.g., a transistor, a diode or the like) may be very low in comparison with a discharge voltage, and therefore the threshold voltage may be approximated to 0V in the following description.

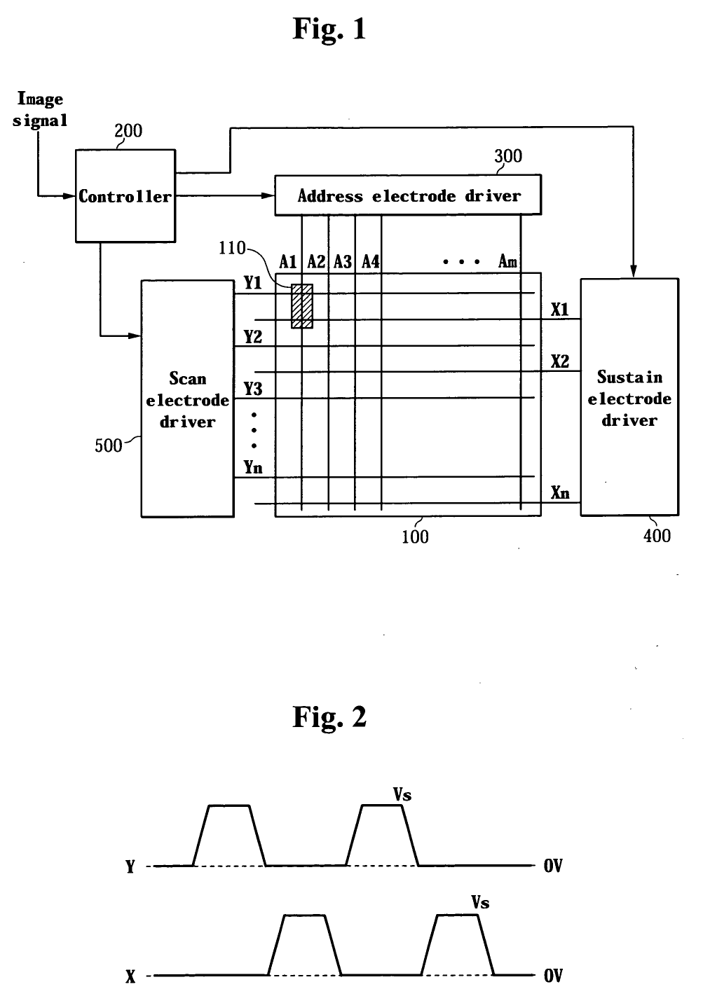

Referring to FIG. 1, the plasma display according to an exemplary embodiment of the present invention includes a plasma display panel (PDP) 100, a controller 200, an address electrode driver 300, a sustain electrode driver 400, and a scan electrode driver 500.

The plasma display panel 100 includes a plurality of address electrodes A1-Am (hereinafter referred to as “A electrodes”) extending in the column direction, and scan electrodes Y1-Yn (hereinafter referred to as “Y electrodes”) and sustain electrodes X1-Xn (hereinafter referred to as “X electrodes”) extending in the row direction. The Xn electrodes X1-Xn correspond to the Y electrodes Y1-Yn. The A electrodes A1-Am cross the Y electrodes Y1-Yn and X electrodes X1-Xn. Discharge spaces are formed at regions where the A electrodes A1-Am cross the X and Y electrodes X1-Xn and Y1-Yn, respectively, and such discharge spaces form discharge cells 110.

The controller 200 externally receives an image signal (e.g., video image signal) and outputs driving control signals. In addition, the controller 200 controls the plasma display by dividing a frame into a plurality of subfields having respective brightness weight values. Each subfield includes an address period and a sustain period. The A, X, and Y electrode drivers 300, 400, and 500, respectively, receive the driving control signals from the controller 200 and apply driving voltages to the respective A electrodes A1-Am, X electrodes X1-Xn, and Y electrodes Y1-Yn.

In more detail, during the address period of each subfield, the A, X, and Y electrode drivers 300, 400, and 500 select the turn-on and turn-off discharge cells of each subfield from among the plurality of discharge cells 110. Referring to FIG. 2, during the sustain period of each subfield, the X electrode driver 400 applies a sustain discharge pulse alternately having a high level voltage Vs and a low level voltage 0V to the plurality of X electrodes X1-Xn by the predetermined number corresponding to the weights of the corresponding subfield. In addition, the Y electrode driver 500 applies a sustain discharge pulse of an inverse phase with respect to the sustain discharge pulse of the plurality of X electrodes X1-Xn, to the plurality of Y electrodes Y1-Yn.

Then, voltage differences between the respective X and Y electrodes alternately have the voltages Vs and -Vs, and accordingly the sustain discharges are repeated by the predetermined number in the turn-on discharge cells.

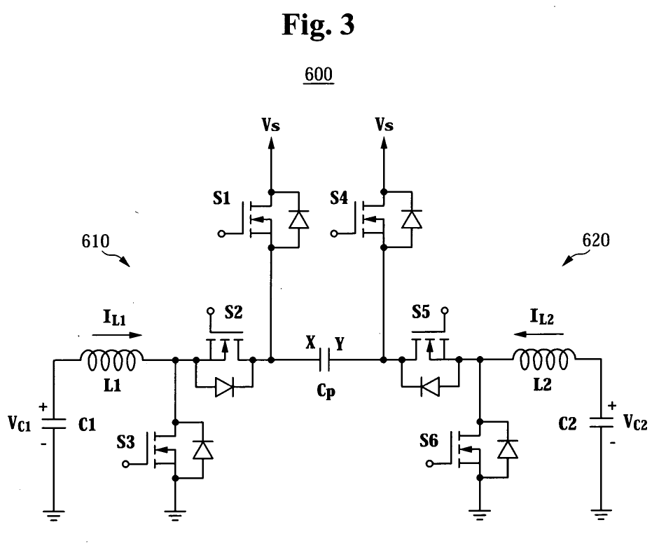

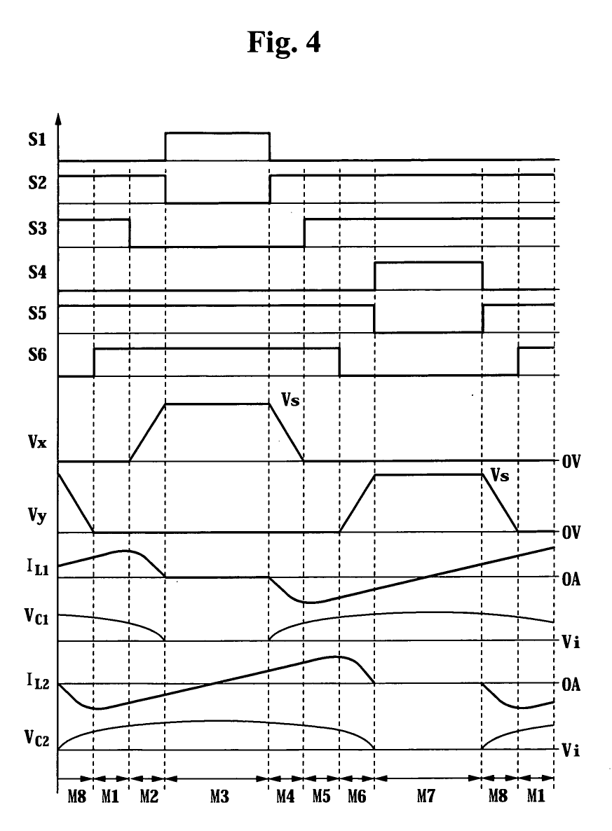

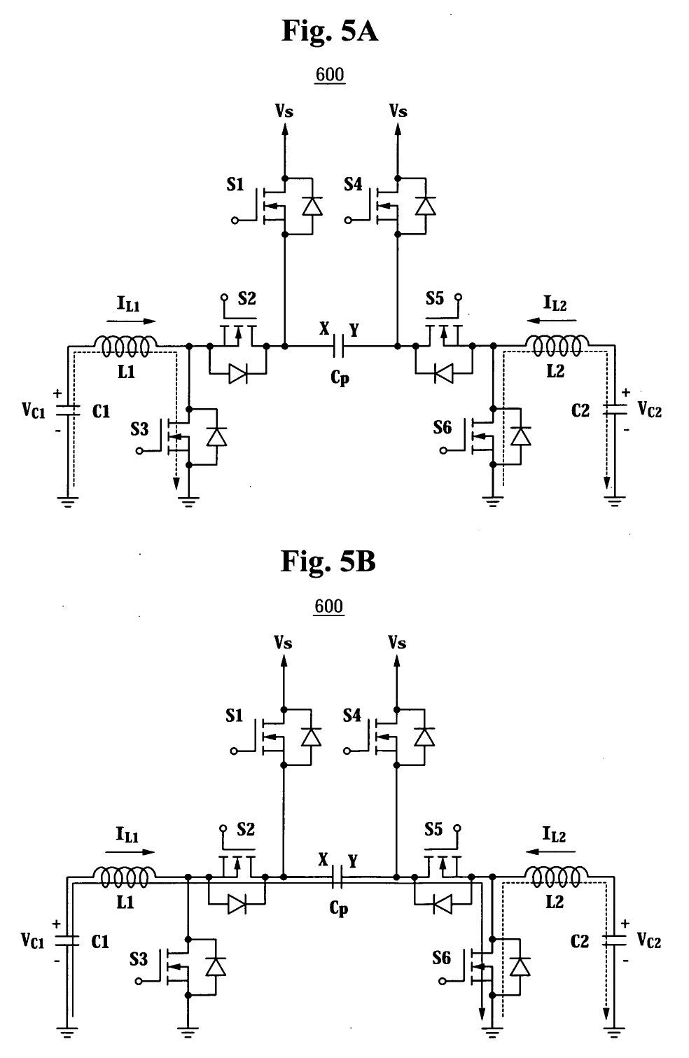

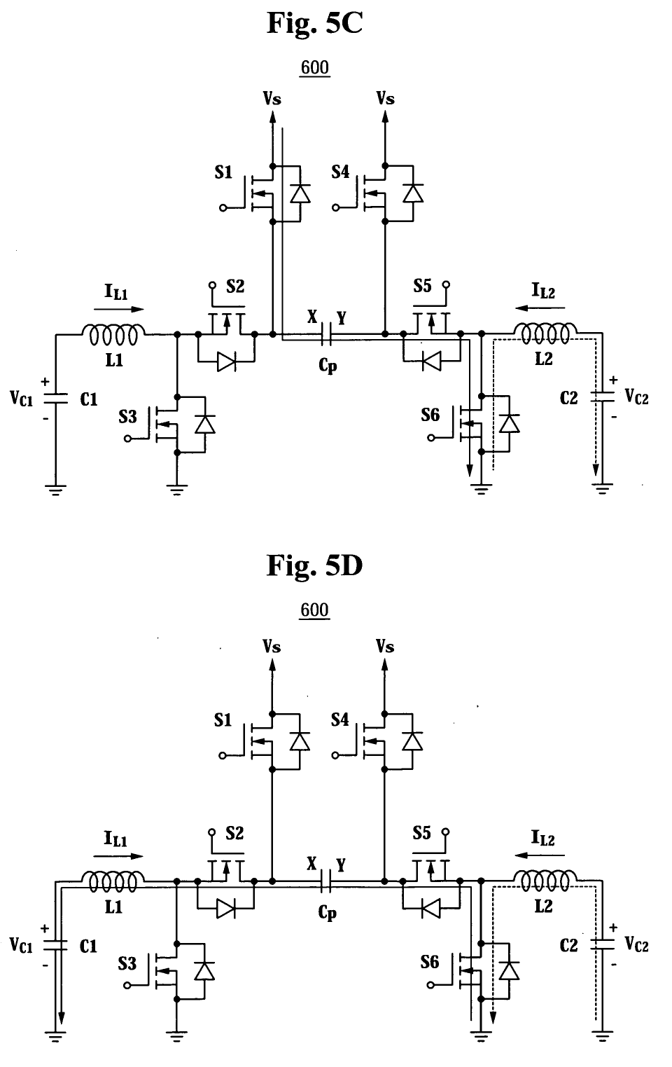

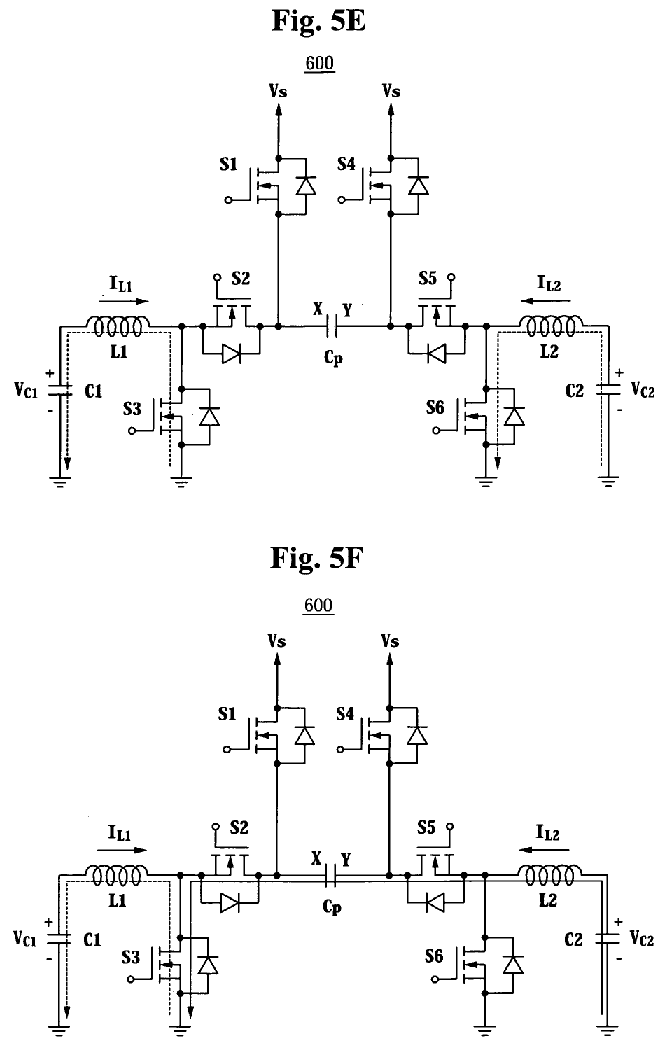

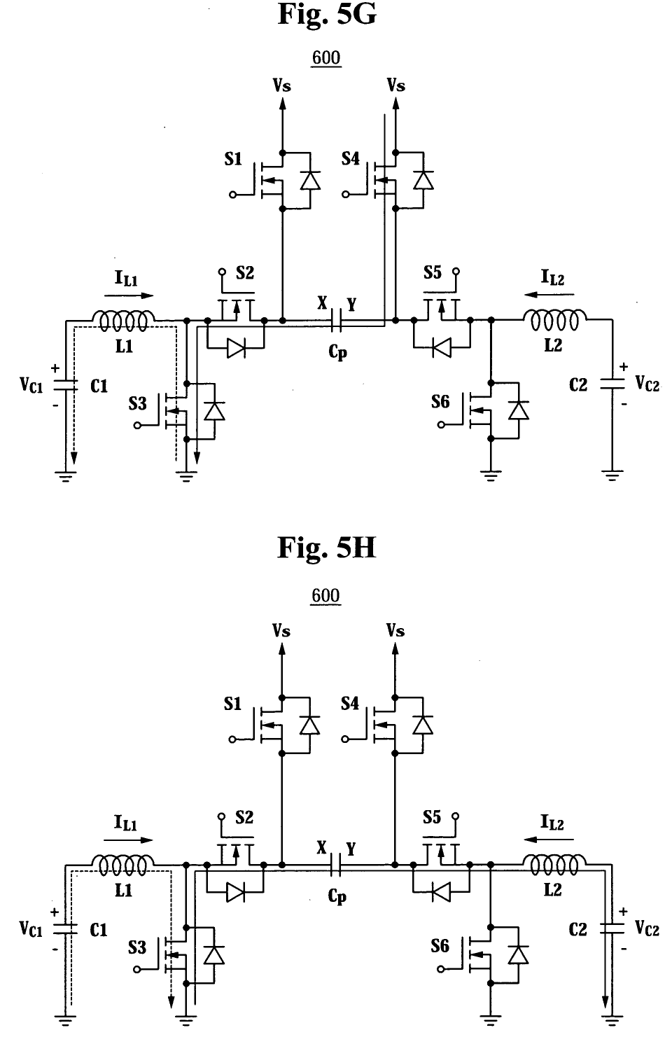

The X electrode driver 400 and the Y electrode driver 500 for supplying the sustain discharge pulses of FIG. 2 will be described in detail with reference to FIG. 3, FIG. 4, and FIGS. 5A, 5B, 5C, 5D, 5E, 5F, 5G and 5H.

FIG. 3 shows a schematic circuit diagram of a sustain discharge circuit 600 formed in the X electrode driver 400 and the Y electrode driver 500 according to an exemplary embodiment of the present invention. Such a sustain discharge circuit 600 may be coupled to the plurality of X electrodes X1-Xn and the plurality of Y electrodes Y1-Yn in common, or be coupled to some electrodes among the plurality of X electrodes X1-Xn and the plurality of Y electrodes Y1-Yn. For better understanding and ease of description, in the sustain discharge circuit 600, one X and one Y electrode are illustrated, and capacitive components formed between the X and Y electrodes are illustrated as a panel capacitor Cp.

As shown in FIG. 3, the sustain discharge circuit 600 according to an exemplary embodiment of the present invention includes an X electrode driving circuit 610 coupled to the X electrode and a Y electrode driving circuit 620 coupled to the Y electrode. The X electrode driving circuit 610 includes transistors S1, S2, and S3, an inductor L1, and a capacitor C1 as an energy recovery power source, and the Y electrode driving circuit 620 includes transistors S4, S5, and S6, an inductor L2, and a capacitor C2 as an energy recovery power source. In FIG. 3, the transistors S1, S2, S3, S4, S5 and S6 are formed by n-channel field effect transistors, particularly n-channel metal oxide semiconductor (NMOS) transistors, and these transistors S1, S2, S3, S4, S5 and S6 have a body diode formed in a direction of a drain from a source. However, the transistors S1, S2, S3, S4, S5 and S6 may be formed by other transistors having similar functions. In addition, it is but one example that the transistors S1 to S6 shown in FIG. 3 are separately formed. Alternatively, the transistors S1 to S6 may be formed by a plurality of transistors coupled in parallel.

In the X electrode driving circuit 610, a drain of the transistor S1 is coupled to a power source Vs for supplying the high level voltage Vs of the sustain discharge pulse, and a source of the transistor S1 and a drain of the transistor S2 are coupled to the X electrode. The transistor S3 has a drain coupled to a source of the transistor S2 and a source couple to a power source for supplying the low level voltage 0v, that is, the ground terminal. The inductor L1 is coupled between a source of the transistor S2 and the capacitor C1. A voltage V_{c1} supplied from the capacitor C1 is given as a voltage Vi that is lower than half (Vs/2) of a difference between the high level voltage Vs and the low level voltage 0V.

The Y electrode driving circuit 620 has a similar circuit structure to the X electrode driving circuit 610. In more detail, a source of the transistor S4 is coupled to the Y electrode and a drain of the transistor S4 is coupled to the power source Vs. A drain of the transistor S5 is coupled to the Y electrode. The transistor S6 has a drain coupled to the source of the transistor S5 and a source coupled to the ground terminal. The inductor L2 is coupled between a source of the transistor S5 and the capacitor C2. In addition, a voltage V_{c2} supplied from the capacitor C2 is given as a voltage Vi that is lower than half (Vs/2) of a difference between the high level voltage Vs and the low level voltage 0V.

An operation of the sustain discharge circuit 410 of FIG. 3 will be described in detail with reference to FIG. 4 and FIGS. 5A, 5B, 5C, 5D, 5E, 5F, 5G and 5H.

FIG. 4 shows a signal timing diagram of a sustain discharge circuit according to a first exemplary embodiment of the present invention, and FIGS. 5A, 5B, 5C, 5D, 5E, 5F, 5G and 5H, respectively, shows a current path of the sustain discharge circuit of FIG. 3 operated according to signal timings of FIG. 4.

As shown in FIG. 4 and FIG. 5A, in the first mode M1, the transistor S6 is turned on while the transistors S2, S3, and S5 are turned on. Then, the ground voltage 0V may be applied to the X and Y electrodes. A current I_{L1} is input into the inductor L₁ through a path of the capacitor C1, the inductor L1, and the transistor S3, and accordingly energy is stored at the inductor L1.

Next, in the second mode M2, the transistor S3 is turned off while the transistors S2, S5, and S6 are turned on. Then, as shown in FIG. 5B, while the voltage Vy of the Y electrode is maintained as 0V, a resonance is generated through a path of the capacitor C1, the inductor L1, a body diode of the transistor S2, a panel capacitor Cp, the transistors S5 and S6, and the ground terminal. The resonance induces a flow of a resonance current I_{L1} to the inductor L1, and the voltage Vx of the X electrode is increased from 0V to the voltage Vs. At this time, the stored energy of the inductor L₁ as well as the stored energy of the capacitor C1 are input to the panel capacitor Cₚ, and accordingly, the voltage Vx of the X electrode is rapidly increased to the voltage Vs. That is, although the sustain discharge circuit has a parasitic component, the voltage Vx of the X electrode may be increased to the voltage Vs. In addition, the voltage Vx of the X electrode may be clamped at the voltage Vs by the body diode of the transistor S1.

In the third mode M3, while the transistors S5 and S6 are turned on, the transistor S1 is turned on. Then, as shown in FIG. 5C, the voltage Vs is applied to the X electrode through the transistor while the voltage Vy of the Y electrode is maintained at 0V. At this time, because the transistor S1 is turned on at the state the voltage X of the X electrode is increased to the voltage Vs, the transistor S1 may be operated with zero-voltage switching.

In the fourth mode M4, while the transistors S5 and S6 are turned on, the transistor S1 is turned off and the transistor S2 is turned on. And then, as shown in FIG. 5D, while the voltage Vy of the Y electrode is maintained at 0V, a resonance is generated through a path of the ground terminal, the body diodes of the transistors S5 and S6, the panel capacitor Cp, the transistor S2, the inductor L1, and the capacitor C1 so that the voltage Vx of the X electrode is decreased from the voltage Vs to 0V. That is, the energy I_{L1} of the panel capacitor Cp is recovered by the capacitor C1 through the inductor L1. At this time, as described above, when the voltage V_{c1} of the capacitor C1 is set to be lower than the voltage Vs/2, the voltage Vx of the X electrode may be rapidly decreased to 0V regardless of the existence of the parasitic components. Also, the voltage Vx of the X electrode may be clamped at 0V by the body diodes of the transistors S2 and S3.

In the fifth mode M5, the transistor S3 is turned on while the transistors S2, S5, and S6 are turned on. Accordingly, the X electrode is applied with 0V while the voltage Vy of the Y electrode is maintained at 0V. In addition, as shown in FIG. 5E, a current I_{L2} is input into the inductor L2 through a path of the capacitor C2, the inductor L2, and the transistor S6, and accordingly, energy is stored at the inductor L2. In addition, the remaining energy I_{L1} of the inductor L1 is recovered by the capacitor C1 through the body diode of the transistor S3 and the inductor L1, and accordingly, the voltage V_{c1} of the capacitor C1 is increased.

Next, in the sixth mode M6, the transistor S6 is turned off while the transistors S2, S3, and S5 are turned on. Then, as shown in FIG. 5F, while the voltage Vx of the X electrode is maintained at 0V, a resonance is generated between the inductor L2 and the panel capacitor Cp through the capacitor C2, the inductor L2, the body diode of the transistor S5, the panel capacitor Cp, the transistors S2 and S3, and the ground terminal. The resonance induces a flow of a resonance current I_{L2} to the inductor L2, and the voltage Vy of the Y electrode is increased from 0V to the voltage Vs. At this time, the stored energy of the inductor L2 as well as the stored energy of the capacitor C2 are input to the panel capacitor Cp, and accordingly, the voltage Vy of the Y electrode is rapidly increased to the voltage Vs. In addition, although the voltage Vy of the Y electrode may be increased above the voltage Vs, the voltage Vy of the Y electrode may be clamped at the voltage Vs by the body diode of the transistor S4. In the sixth mode M6, the remaining current I_{L1} of the inductor L1 is continuously recovered by the capacitor C1.

In the seventh mode M7, while the transistors S2 and S3 are turned on, the transistor S4 is turned on and the transistor S5 is turned off. Then, as shown in FIG. 5G, while the voltage Vx of the X electrode is maintained at 0V, the voltage Vs is applied to the Y electrode through the transistor S4. After the remaining current I_{L1} of the inductor L1 is substantially recovered by the capacitor C1, the energy of the capacitor C1 is input into the inductor L1 by turning on of the transistor S3 and thus the voltage V_{c1} of the capacitor C1 is decreased.

In the eighth mode M8, while the transistors S2 and S3 are turned on, the transistor S4 is turned off and the transistor S5 is turned on. Then, as shown in FIG. 5H, while the voltage Vx of the X electrode is maintained at 0V, a resonance is generated through a path of the ground terminal, the body diode of the transistors S3 and S2, the panel capacitor Cp, the transistor S5, the inductor L2, and the capacitor C2, and thus the voltage Vy of the Y electrode is decreased from the voltage Vs to 0V. That is, the energy I_{L2} of the panel capacitor Cp is recovered by the capacitor C2 through the inductor L2. At this time, the energy I_{L1} of the capacitor C1 continues to be input into the inductor L1 since the transistor S3 remains turned on.

Again referring to the second mode M2, when the voltage V_{c1} of the capacitor C1 is set to be lower than the voltage Vs/2, the voltage Vx of the X electrode may be rapidly decreased to 0V regardless of the existence of the parasitic components because the resonance is generated in the energy input state of the inductor L1 in the modes M7 and M8 as well as in the first mode M1. Particularly, in the fourth mode M4, in order to maintain sufficient energy I_{L1} at the inductor L1 after rapidly decreasing the voltage Vx of the X electrode, the voltage V_{c1} of the capacitor C1 may be set to be lower than a voltage Vs/4, particularly, a voltage Vs/8. Then, during a period (e.g., ⅛ period) that is shorter than ¼ of the resonance period, the voltage Vx of the X electrode is decreased to 0V and a great deal of energy I_{L1} may be maintained in the inductor L1. As described above, since the energy I_{L1} is recovered by the capacitor C1 in the modes M5, M6, and M7, and then is again input into the inductor L1 in the modes M7, M8, and M1, the voltage Vx of the X electrode is rapidly increased in the second mode M2.

When the voltage V_{c2} of the capacitor C2 is set to be lower than the voltage Vs/4 as the capacitor C1, in the eighth mode M8, the voltage Vy of the Y electrode may be rapidly decreased. In addition, after the resonance of the eighth mode M8, the remaining energy I_{L2} of the inductor L2 may be recovered by the capacitor C2 through the body diode and inductor L2 in the modes 1 to 3 M1 to M3. After all the remaining energy I_{L2} of the inductor L2 is recovered by the capacitor C2, the energy I_{L2} of the capacitor C2 may be input to the inductor L2 by turning on the transistor S3 in the modes M3 to M5. Accordingly, since the resonance is generated in the sixth mode M6 when the energy I_{L2} is input into the inductor L2 during the modes M3, M4 and M5, the voltage Vy of the Y electrode may be rapidly increased to the voltage Vs.

As described above, according to an exemplary embodiment of the present invention, during the sustain period, the modes M1, M2, M3, M4, M5, M6, M7 and M8 are repeated by the number of times corresponding to a weight value of the corresponding subfield, and accordingly, the X and Y electrodes may be applied with a sustain discharge pulse of inverse phases alternately having the high level voltage Vs and the low level voltage 0V.

In addition, since the voltage of the X electrode or Y electrode is increased or decreased by one transistor S2 or S5, the number of transistors and diodes may be reduced in comparison with a circuit separately using the transistors and diodes for increasing and decreasing a voltage. In addition, since the path for freely wheeling current of the inductors L1 and L2 is formed through the body diode of the transistors S3 and S6, the clamping diode need not be additionally used.

It is one example that the high and low level voltages of the sustain discharge pulse applied to the X and Y electrodes are respectively set as the voltages Vs and 0V. Accordingly, different voltages may be used as the high level voltage and low level voltage. That is, voltages may be used such that the difference between the high level voltage applied to the X electrode and the low level voltage applied to the Y electrode is the voltage Vs and the difference between the low level voltage applied to the X electrode and the high level voltage applied to the Y electrode is the voltage -Vs. For example, the high level voltage applied to the X and Y electrodes may be set as the voltage Vs/2, and the low level voltage applied to the X and Y electrodes may be set as the voltage Vs/2.

According to an exemplary embodiment of the present invention, the number of the transistors and diodes may be reduced in the sustain discharge circuit. In addition, when the sustain discharge pulse is applied to the X and Y electrodes, the zero voltage switching may be achieved.

While exemplary embodiments of this invention have been described it is to be understood that the invention is not limited to the disclosed embodiments, but, on the contrary, is intended to cover various modifications and equivalent arrangements included within the spirit and scope of the appended claims.

What is claimed is:

1. A plasma display comprising:
a plurality of first electrodes;
a plurality of second electrodes;
a first transistor coupled between the plurality of first electrodes and a first power source for supplying a first voltage;
a second transistor having a body diode and being coupled to the plurality of first electrodes at a first terminal;
a third transistor coupled between a second terminal of the second transistor and a second power source for supplying a second voltage;
a first inductor coupled between the second terminal of the second transistor and a first energy recovery power source;
a fourth transistor coupled between the plurality of second electrodes and the first power source;
a fifth transistor having a body diode and being coupled to the plurality of second electrodes at a first terminal;
a sixth transistor coupled between a second terminal of the fifth transistor and the second power source; and
a second inductor coupled between the second terminal of the fifth transistor and a second energy recovery power source.

2. The plasma display of claim 1, wherein the body diode of the second transistor forms a current path from the first terminal to the second terminal, and the body diode of the fifth transistor forms a current path from the first terminal to the second terminal.

3. The plasma display of claim 2, wherein each of the first transistor, the third transistor, the fourth transistor and the sixth transistor have a body diode.

4. The plasma display of claim 3, wherein each of the first energy recovery power source and the second energy recovery power source supply a voltage of lower than approximately half of a third voltage corresponding to a difference between the first and second voltages.

5. The plasma display of claim 4, wherein the first energy recovery power source and the second energy recovery power source each supplies a voltage of lower than approximately ¼ of the third voltage.

6. The plasma display of claim 5, wherein the first energy recovery power source and the second energy recovery power source each supplies a voltage corresponding to approximately ⅛ of the third voltage.

7. The plasma display of claim 4, further comprising:
a controller:
adapted to set the second transistor, the third transistor, the fifth transistor, and the sixth transistor to be turned on during a first mode;
adapted to set the second transistor, the fifth transistor, and the sixth transistor to be turned on during a second mode subsequent to the first mode;
adapted to set the first transistor, the fifth transistor, and the sixth transistor to be turned on during a third mode subsequent to the second mode;
adapted to set the second transistor, the fifth transistor, and the sixth transistor to be turned on during a fourth mode subsequent to the third mode;
adapted to set the second transistor, the third transistor, the fifth transistor, and the sixth transistor to be turned on during a fifth mode subsequent to the fourth mode;
adapted to set the second transistor, the third transistor, and the fifth transistor to be turned on during a sixth mode subsequent to the fifth mode;
adapted to set the second transistor, the third transistor, and the fourth transistor to be turned on during a seventh mode subsequent to the sixth mode; and
adapted to set the second transistor, the third transistor, and the fifth transistor to be turned on during an eighth mode subsequent to the seventh mode.

8. The plasma display of claim 4, wherein each of the first transistor, the second transistor, the third transistor, the fourth transistor, the fifth transistor and the sixth transistor is an n-channel metal oxide semiconductor transistor.

9. A driving method of a plasma display having a first electrode, the driving method comprising:
inputting energy of a first capacitor into a first inductor while applying a first voltage to a first electrode during a first period;
inputting stored energy of the first inductor and energy of the first capacitor into the first electrode through a body diode of a first transistor coupled between the first inductor and the first electrode during a second period;
applying a second voltage that is higher than the first voltage to the first electrode during a third period;
recovering the stored energy of the first electrode to the first capacitor through the first transistor and the first inductor during a fourth period; and
applying the first voltage to the first electrode during a fifth period.

10. The driving method of claim 9, further comprising:
applying the first voltage to a second electrode of the plasma display device during the third period; and
applying the second voltage to the second electrode during the fifth period.

11. The driving method of claim 9, further comprising:
inputting energy of a second capacitor into a second inductor while applying the first voltage to a second electrode of the plasma display device during a first sub-period of the fifth period;
inputting energy of a second capacitor and stored energy of the second inductor into the second electrode through a body diode of a second transistor coupled between the second inductor and the second electrode during a second sub-period of the fifth period;
applying the second voltage to the second electrode during a third sub-period of the fifth period; and
recovering the stored energy of the second electrode to the second capacitor through the second transistor and the second inductor during a fourth sub-period of the fifth period.

12. The driving method of claim 11, further comprising applying the first voltage to the second electrode during the first period, the second period, the third period, and the fourth period.

13. The driving method of claim 12, wherein the first inductor retains a first remaining energy after recovering the stored energy of the first electrode, and the second inductor retains a second remaining energy after recovering the stored energy of the second electrode,
wherein the driving method further comprises:
recovering the second remaining energy to the second capacitor during the first period, the second period, and a first portion of the third period;
further inputting energy of the second capacitor into the second inductor during a second portion of the third period and the fourth period;
recovering the first remaining energy to the first capacitor during the first sub-period, the second sub-period, and a first portion of the third sub-period; and
inputting energy of the first capacitor into the first inductor during a second portion the third sub-period and the fourth sub-period.

14. The driving method of claim 9, wherein recovering the stored energy of the first electrode to the first capacitor further comprises forming a resonance between the first inductor and a capacitive component formed by the first electrode and the second electrode during a period of less than approximately ¼ of a resonance period.

15. A driving apparatus of a plasma display having a first electrode and a second electrode for performing a sustain discharge along with the first electrode, the driving apparatus comprising:
a first transistor having a first terminal adapted to be coupled to a first power source for supplying a first voltage, a second terminal adapted to be coupled to the first electrode, and a body diode enabling the formation of a current path from the second terminal to the first terminal;
a second transistor having a first terminal adapted to be coupled to the first electrode, a second terminal, and a body diode enabling the formation of a current path from the second terminal of the second transistor to the first terminal of the second transistor;
a third transistor having a first terminal coupled to the second terminal of the second transistor, a second terminal adapted to be coupled to a second power source for supplying a second voltage, and a body diode enabling the formation of a current path from the second terminal of the third transistor to the first terminal of the third transistor;
a first capacitor for supplying a voltage of lower than approximately half of the difference between the first voltage and the second voltage; and
a first inductor coupled between the first capacitor and the second terminal of the second transistor.

16. The driving apparatus of claim 15, further comprising:
a fourth transistor having a first terminal adapted to be coupled to the first power source, a second terminal adapted to be coupled to the second electrode, and a body diode enabling the formation of a current path from the second terminal of the fourth transistor to the first terminal of the fourth transistor;
a fifth transistor having a first terminal adapted to be coupled to the second electrode, a second terminal, and a body diode enabling the formation of a current path from the second terminal of the fifth transistor to the first terminal of the fifth transistor;
a sixth transistor having a first terminal coupled to a second terminal of the fifth transistor, a second terminal adapted to be coupled to the second power source, and a body diode enabling the formation of a current path from the second terminal of the sixth transistor to the first terminal of the sixth transistor;
a second capacitor for supplying a voltage of lower than approximately half of the difference between the first voltage and the second voltage; and
a second inductor coupled between the second terminal of the fifth transistor and the second capacitor.

17. The driving apparatus of claim 15, wherein the first capacitor supplies a voltage of lower than approximately ¼ of the difference between the first voltage and the second voltage.

18. A plasma display comprising the driving apparatus of claim 15.
